(19) United States
(12) Patent Application Publication
(10) Pub. No.: US 2018/0276428 A1
(43) Pub. Date: Sep. 27, 2018

(54) SYSTEMS AND METHODS FOR CONSUMER ITEM TRACKING USING SENSOR DETECTION IN DEFINED LOCATIONS

(71) Applicant: Photon Technologies Inc., Fremont, CA (US)

(72) Inventor: Venkata S. Kakani, Fremont, CA (US)

(21) Appl. No.: 15/923,888

(22) Filed: Mar. 16, 2018

Related U.S. Application Data
(60) Provisional application No. 62/473,289, filed on Mar. 17, 2017.

(51) Int. Cl. G06K 7/10; G06Q 10/08; G06K 19/07; G06Q 30/06; G06N 99/00

(52) U.S. Cl. CPC G06K 7/10306; G06Q 10/087; G06N 99/005; G06Q 30/0633; G06K 19/0723

(57) ABSTRACT

Systems and methods for tracking consumer items using sensor detection. An inventory tracking system includes one or more sensors configured to detect consumer items, which includes at least one of: a first sensor configured to detect consumer items within a first area of a household in which the consumer items are used; and a second sensor configured to detect consumer items within a second area of the household either in which the consumer items are discarded or through which the consumer items pass before being discarded. The system includes a computing device comprising at least one processor configured to perform the steps of: maintaining a real-time inventory of consumer items based on information received from the one or more sensors; and computing a usage of each consumer item based on information received from the one or more sensors and an usage formula.

### CROSS-REFERENCE TO RELATED APPLICATION

This application claims priority to and the benefit of U.S. Provisional Patent Application No. 62/473,289, filed on Mar. 17, 2017, the entirety of which is incorporated by reference herein.

### TECHNICAL FIELD

The present disclosure relates generally to tracking consumer items and, more particularly, to systems and methods for tracking consumer items with the use of radio frequency identification (RFID) sensors and tags based on computed usage of the consumer items.

### BACKGROUND

Commonly-used household items such as groceries, cleaning supplies, batteries, and the like need often to be replenished by the consumer. Moreover, the criticality and/or rate of replenishment for such household items varies from item to item. For instance, diapers may need to ordered at a much greater rate than bars of soap. Due to increasingly busy lives, it is often inconvenient for a consumer to determine when a supply of a particular item will run out and need to be replenished.

### SUMMARY

Systems and methods for tracking consumer items are described. In one aspect, an inventory tracking system includes one or more sensors configured to detect consumer items. The one or more sensors includes at least one of: a first sensor configured to detect consumer items within a first area of a household in which the consumer items are used; and a second sensor configured to detect consumer items within a second area of the household either in which the consumer items are discarded or through which the consumer items pass before being discarded. The system includes a computing device comprising at least one processor and at least one memory storing executable instructions that, when executed by the at least one processor, cause the at least one processor to perform the steps of: maintaining a real-time inventory of consumer items in the household based on information received from the one or more sensors; computing a usage of each consumer item based on information received from the one or more sensors and an usage formula; and generating a list of consumer items needing replenishment based on information received from the one or more sensors and the computed usages.

The present aspect can include one or more of the following features. At least one of the first sensor and second sensor is an RFID sensor configured to detect RFID tags affixed to consumer items. At least one of the RFID sensors comprises a UHF RFID sensor configured to radiate with frequency in a range between 900 to 950 MHz. The RFID tags is affixed to the consumer items by a service provider as part of a process of delivering the consumer items to the household. The RFID tags includes low cost UHF RFID paper tags or plastic tags. A housing of the RFID sensor comprises acrylic plastic such that RFID sensor is able to detect RFID tags through the acrylic plastic. At least one of the first sensor and second sensor is a vision-based sensor configured detect the consumer items. At least one of the first sensor and second sensor is a sound-based configured to sense one or more sounds associated with the consumer items. Generating the list of consumer items includes predicting a likelihood that the household will need to replenish a particular consumer item using a machine learning algorithm. The steps can further include providing, via a user interface of the system, the list of consumer items to a customer associated with the household; receiving, via the user interface, modifications of the list, if any, from the customer; and providing the list of consumer items, with any modifications, to a service provider for replenishment of the listed consumer items.

The present aspect can include one or more of the following features. The usage is computed based on average use per a recurring time period. The time period is selected from the group consisting of a second, an hour, a day, a week, a month, and multiples of the foregoing. The computing the usage of each consumer item further includes: (i) computing average product usage for the consumer item; (ii) computing estimated quantity of the consumer item in the household based on the average product usage; (iii) computing a life of the consumer item; and (iv) providing, via a user interface of the system, a recommendation for purchase of the consumer item based on the computed life. The computing the usage of each consumer item further includes determining a criticality of the consumer item, wherein the average product usage is computed based on the criticality. The computing the usage of each consumer item further comprises: determining at least one of purchase or delivery of the consumer item to the household; if the consumer item is purchased or delivered to the household, repeating (i)-(iv); and if the consumer item is not purchased or delivered to the household, determining future usage of the consumer item. If the consumer item is not purchased or delivered to the household, the steps further include removing the consumer item from the list of consumer items. The system can further include at least one of: a first motion sensor coupled to the first sensor and configured to detect motion within the first area of the household, wherein the second motion sensor activates the first sensor upon detecting motion in the first area; and a second motion sensor coupled to the second sensor and configured to detect motion within the second area of the household, wherein the second motion sensor activates the second sensor upon detecting motion in the second area.

In another aspect, in an inventory tracking system comprising one or more sensors configured to detect consumer items, a method can include configuring at least one of: a first sensor to detect consumer items within a first area of a household in which the consumer items are used; and a second sensor to detect consumer items within a second area of the household either in which the consumer items are discarded or through which the consumer items pass before being discarded. The method can further include maintaining, using a computing device, a real-time inventory of consumer items in the household based on information received from the one or more sensors; computing, using the computing device, a usage of each consumer item based on information received from the one or more sensors and an usage formula; and generating, using the computing device, a list of consumer items needing replenishment based on information received from the one or more sensors and the computed usages.

The present aspect can include one or more of the following features. At least one of the first sensor and second sensor is an RFID sensor configured to detect RFID tags affixed to consumer items. At least one of the RFID sensors comprises a UHF RFID sensor configured to radiate with frequency in a range between 900 to 950 MHz. The RFID tags is affixed to the consumer items by a service provider as part of a process of delivering the consumer items to the household. The RFID tags includes low cost UHF RFID paper tags or plastic tags. A housing of the RFID sensor comprises acrylic plastic such that RFID sensor is able to detect RFID tags through the acrylic plastic. At least one of the first sensor and second sensor is a vision-based sensor configured detect the consumer items. At least one of the first sensor and second sensor is a sound-based configured to sense one or more sounds associated with the consumer items. Generating the list of consumer items includes predicting a likelihood that the household will need to replenish a particular consumer item using a machine learning algorithm. The steps can further include providing, via a user interface of the system, the list of consumer items to a customer associated with the household; receiving, via the user interface, modifications of the list, if any, from the customer; and providing the list of consumer items, with any modifications, to a service provider for replenishment of the listed consumer items.

The present aspect can include one or more of the following features. The usage is computed based on average use per a recurring time period. The time period is selected from the group consisting of a second, an hour, a day, a week, a month, and multiples of the foregoing. The computing the usage of each consumer item further includes: (i) computing average product usage for the consumer item; (ii) computing estimated quantity of the consumer item in the household based on the average product usage; (iii) computing a life of the consumer item; and (iv) providing, via a user interface of the system, a recommendation for purchase of the consumer item based on the computed life. The computing the usage of each consumer item further includes determining a criticality of the consumer item, wherein the average product usage is computed based on the criticality. The computing the usage of each consumer item further comprises: determining at least one of purchase or delivery of the consumer item to the household; if the consumer item is purchased or delivered to the household, repeating (i)-(iv); and if the consumer item is not purchased or delivered to the household, determining future usage of the consumer item. If the consumer item is not purchased or delivered to the household, the steps further include removing the consumer item from the list of consumer items. The method can further include at least one of: a first motion sensor coupled to the first sensor and configured to detect motion within the first area of the household, wherein the second motion sensor activates the first sensor upon detecting motion in the first area; and a second motion sensor coupled to the second sensor and configured to detect motion within the second area of the household, wherein the second motion sensor activates the second sensor upon detecting motion in the second area.

### BRIEF DESCRIPTION OF THE DRAWINGS

FIG. 1 depicts an example system configuration including two RFID sensors positioned in different physical areas of the household.

FIG. 2 depicts an example RFID scanning device, or sensor, that can be used in the system depicted in FIG. 1 in the trash area and/or usage area.

FIG. 3 depicts a front view of the scanning device of FIG. 2.

FIGS. 4A-4B depict side and front views of another scanner device configuration that can be used in the present system.

FIG. 5 depicts one implementation of a scanning device that can be placed, for example, in or around the usage area.

FIGS. 6A-6C depict an exemplary implementation of an antenna assembly for a scanning device.

FIG. 7 depicts an experimental set-up of the antenna assembly for the purposes of characterizing its polarization responses.

FIGS. 8A-8B depict the vertical polarization responses of a reference antenna and the antenna assembly, respectively.

FIGS. 9A-9B depict the horizontal polarization responses of a reference antenna and the antenna assembly, respectively.

FIGS. 10A-10B depict an exemplary implementation of an antenna assembly for a scanning device. FIG. 10C depicts an exemplary implementation of the packaging of the RFID scanning device.

FIGS. 11A-11B depict methods for tracking consumer items using the exemplary scanning device described herein.

FIG. 12 depicts a method for determining the recommendation of a particular consumer item to the consumer of the household.

### DETAILED DESCRIPTION

Described herein in various implementations are methods and accompanying systems for tracking and automating inventory at a physical location. Inventory can include consumer or other products that are used periodically and then discarded, such as groceries and other consumable items. Physical locations can include a consumer's household, a place of business, a warehouse, and other locations in which the disclosed techniques can be applied. In some implementations, inventory is tracked using radio frequency identification (RFID) tags and readers; however, it is to be appreciated that other types of tracking techniques can be used instead of or in addition to RFID, such as vision-based tracking using object recognition, sound-based, and wireless signal emitters/readers other than RFID. For example, a sound-based sensor positioned in a usage area can be used to determine usage of a particular item. For example, a blender sound in the morning can be correlated to fruit consumption; the sounds associated with the opening and closing of a refrigerator door in the morning can be correlate to half-and-half or orange juice consumption; a flushing sound from the bathroom can be correlated to the use of hand soap and/or toilet paper; a brushing sound can be correlate to use of toothpaste and/or floss; a washing machine sound can be correlated to the use of detergent, fabric softener, bleach, and the like; a dryer machine sound can be correlated with the consumption of fabric softener sheets; etc. In some implementations, the detection of these sounds can be combined with the actual trashing event (trashing of the particular item or packaging).

In any event, RFID is useful for a number of reasons when incorporated into the disclosed systems. For instance, RFID technology is at a stage where tags are easily detected over large distances given enough power of the emitter (e.g., on the order of 10-15 W). Further, home environments are very small and a high-power device can easily locate objects that are outside the area which we intend to find them. Motion sensing or proximity sensing, although optional, is useful to incorporate, because it indicates to the system that the user is present in the vicinity, and sensing at that time gives an accurate reading of items that are present in the scanned area. Motion or proximity sensing also give the added benefit of reducing power consumption of the RFID scanner significantly and reducing heat dissipation by the RFID scanner. In addition to saving energy, the reduction of heat dissipation also improves the longevity of the RFID scanner by reducing mechanical and/or electrical stresses due to the heat dissipation.

Note that the RFID tag may be affixed to the consumer item itself, to its packaging, or to a subpackaging. The choice of affixing can depend on the materials used and how the item is used. For example, batteries have metallic components that will interfere with the operation of RFID scanners. Comparatively, the packaging of the batteries (which are made of plastic or paper) can be more readily affixed with an RFID tag.

### Scanning System

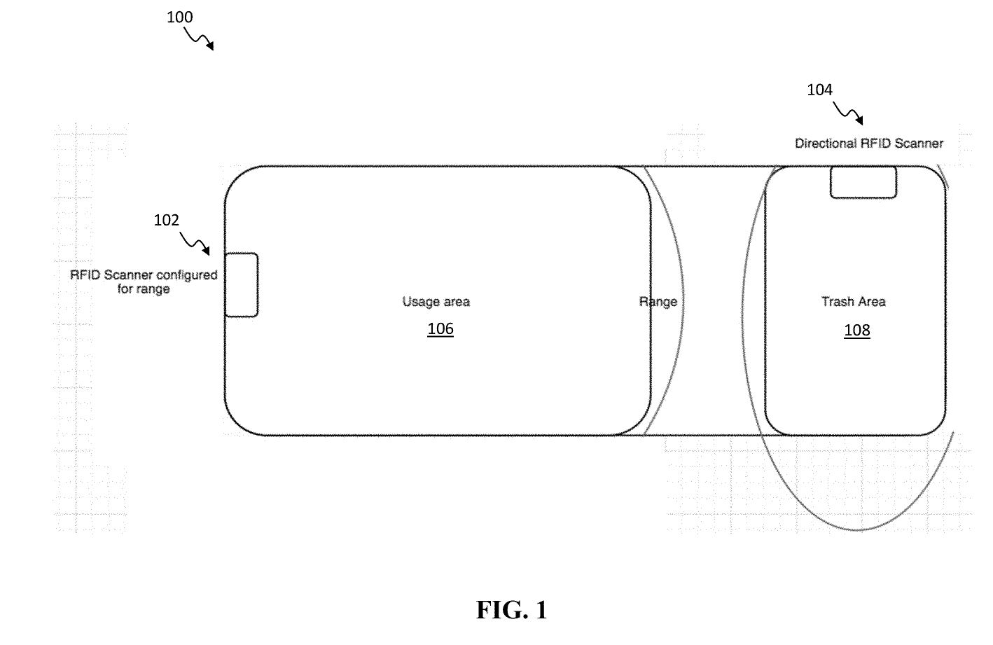

In one implementation of the present system, usage/disposal tracking and ordering of grocery items in a household is entirely or almost entirely automated. FIG. 1 depicts an example system configuration 100 including two RFID sensors 102, 104 positioned in different physical areas of the household. As shown, two separate areas are defined in the household: a usage area 106, where the grocery items are used (e.g., removed from fridge or cabinet, consumed in whole or in portions, etc.), and a trash area 108, where the grocery items are discarded or where they pass through on their way to being discarded (e.g., to an area where trash bins are located, such as the corner of a kitchen, garage, etc.). The usage area RFID sensor 102 is configured (e.g., by adjusting signal strength) to detect RFID tags within a particular range that covers all or substantially all of the usage area. Likewise, the trash area RFID sensor 104 is configured to detect RFID tags within a particular range that covers all or substantially all of the trash area. The locations and properties of the RFID sensors can be selected based on the size and shape of the household area to be monitored. In some instances, the RFID sensors can utilize shielding and/or directional antennas to result in RFID sensing ranges that substantially correspond with the physical areas to be monitored. For example, RFID sensor 104 is a directional-type scanner that is configured to detect RFID tags in the trash area. In other implementations, the system functions with only a trash area sensor, which determines when items have been discarded and need to be replenished. In further implementations, multiple scanning devices are used in the system, allowing for triangulation of the location and orientation of tags in a desired area. In even further implementations, a particular area may include multiple subareas. For example, if there are two trash bins on opposite sides of a room, the trash area may include two subareas, one surrounding each trash bin.

### Scanning Device(s)

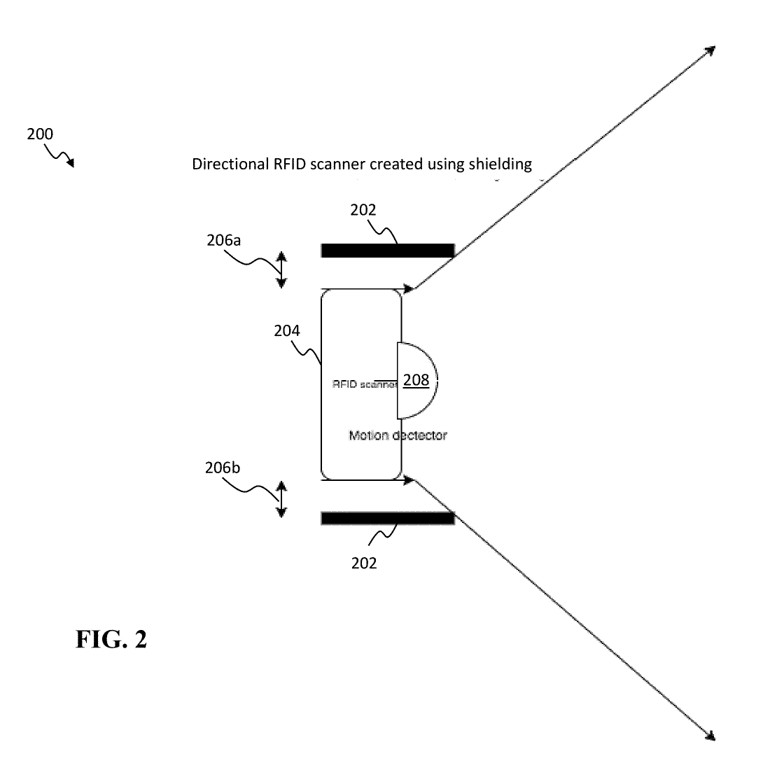

FIG. 2 depicts an example RFID scanning device, or sensor, 200 that can be used in the system 100 depicted in FIG. 1, for example, in the trash area and/or usage area. The scanning device 200, shown in a top cross-sectional view, can include a configurable metal shielding 202 and three or more sensors. In one implementation, the scanning device includes the following features:
1. UHF RFID scanner with configurable power (range) 204. The power can be reduced or increased depending on the size of the area to scan, obstacles, and the size and chip in the tag affixed to an item.
2. RFID antenna, which can be disposed along the outer boundary of the device or in a suitable position within the device. The RFID antenna can also be placed separately from the device and connected with the device using wired or wireless communication. In one implementation, the antenna forms a circular or semi-circular shape; however, other forms, such as rectangular, square or circular/rectangular plate are contemplated, as discussed in the examples provided below.
3. Configurable shielding 202, which can be disposed slightly higher than the RFID antenna. The shielding 202, can be moved closer or farther away (arrows 206a, 206b) from the antenna, thereby focusing the beam. The depicted shielding 202 is circular, but in other implementations can include shielding in rectangular or other forms, provided such shielding is able to shield one or more sides of the device from emitting a signal.
4. Motion detector 208 to determine when a person has entered the area associated with the scanning device and cause the RFID scanner to be activated.

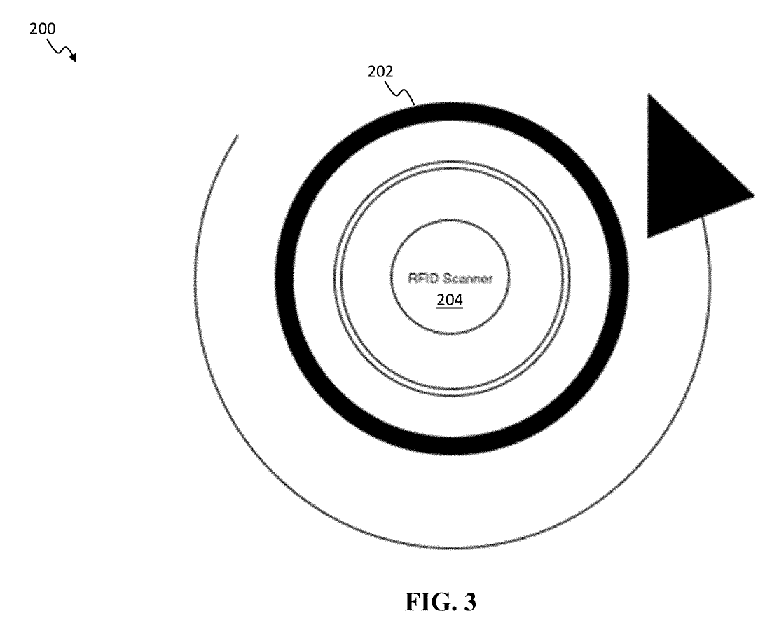

FIG. 3 depicts a front view of the scanning device 200 of FIG. 2. The shielding 202, although depicted as a full circle, can be made of two or more overlapping arcs. These arcs can be moved in a circular fashion to create one or more “holes” in the shield to allow signals to pass through. This allows the scanning device 200 is to sense items in each direction. Alternative shapes can be used to achieve the same purpose by inserting/removing metal plates from the device enclosure. Examples of the foregoing include a square with four or more plates that can be placed/removed, and a hexagon with each side as a plate.

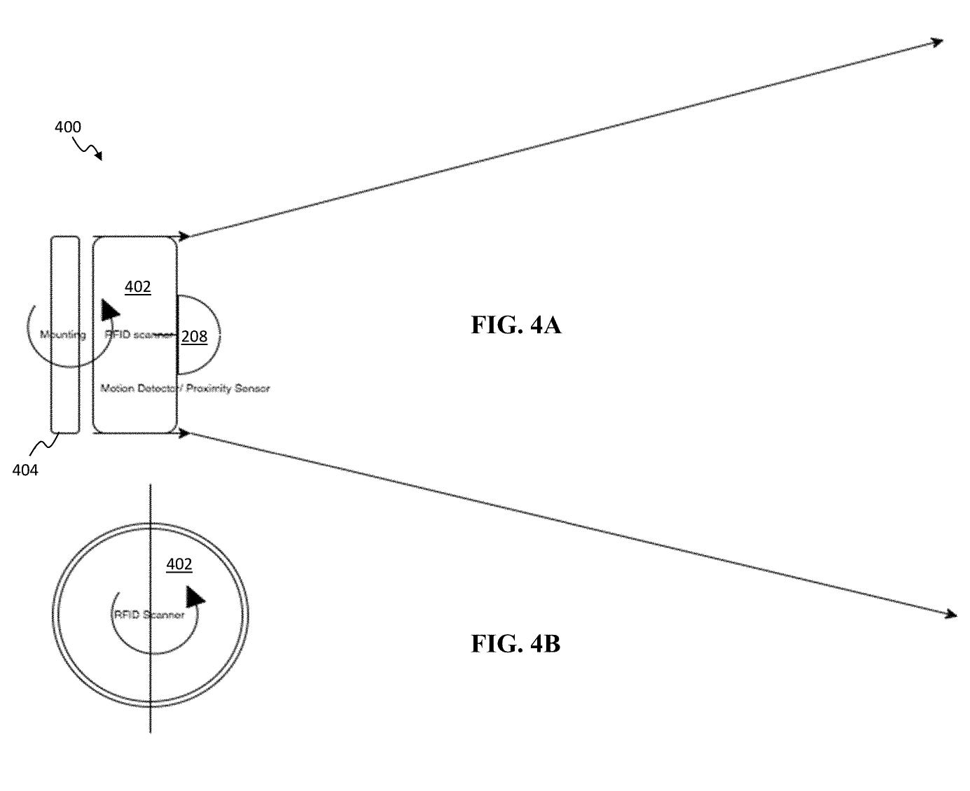

FIGS. 4A-4B depict side and front views of another scanner device 400 configuration that can be used in the present system. As shown, the scanning device 400 can include a directional scanner 402 having a configurable power setting and a mounting component 404 coupled to the directional scanner 402 that can be rotated automatically or manually on one or more axes (e.g., between 0 and 90 degrees, 0 and 180 degrees, etc.), thereby allowing the directional scanner 402 to detect tagged items in a particular directional area. In one implementation, this scanner configuration is configured to monitor the trash area, which may be a narrow area and thus necessitate the use of a directional RFID antenna.

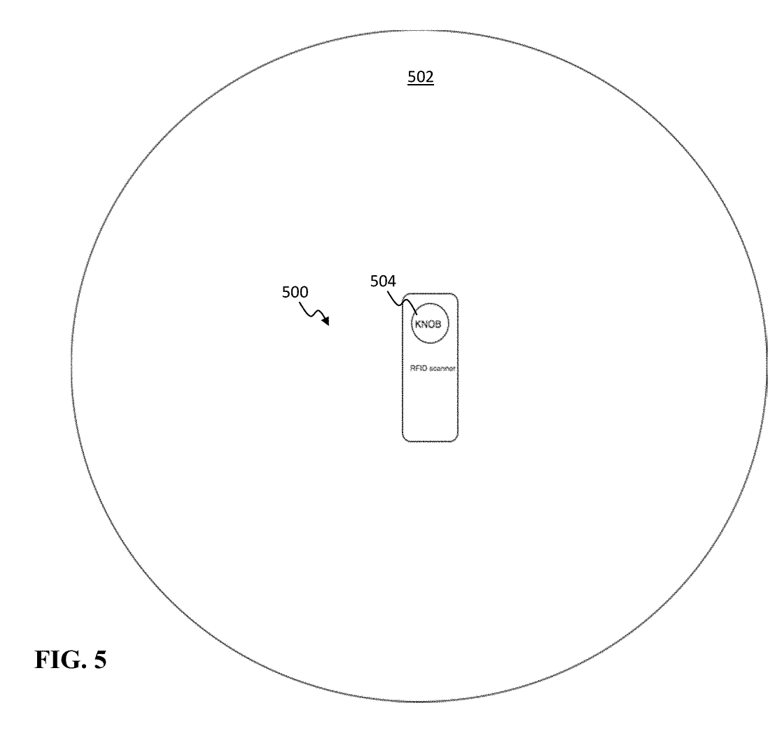

FIG. 5 depicts one implementation of a scanning device 500 that can be placed, for example, in or around the usage area 502. The depicted scanning device 500 can be, for example, an off-the-shelf scanner with a variable power control (e.g., an adjustment knob) 504. The positioning of the scanner and its power can be configured to form a scanning area that approximately covers the usage area 502 or other desired physical region. The depicted scanning device 500 can be used in conjunction with a trash area directional scanner 400 to track consumer items within a household according to the techniques described herein.

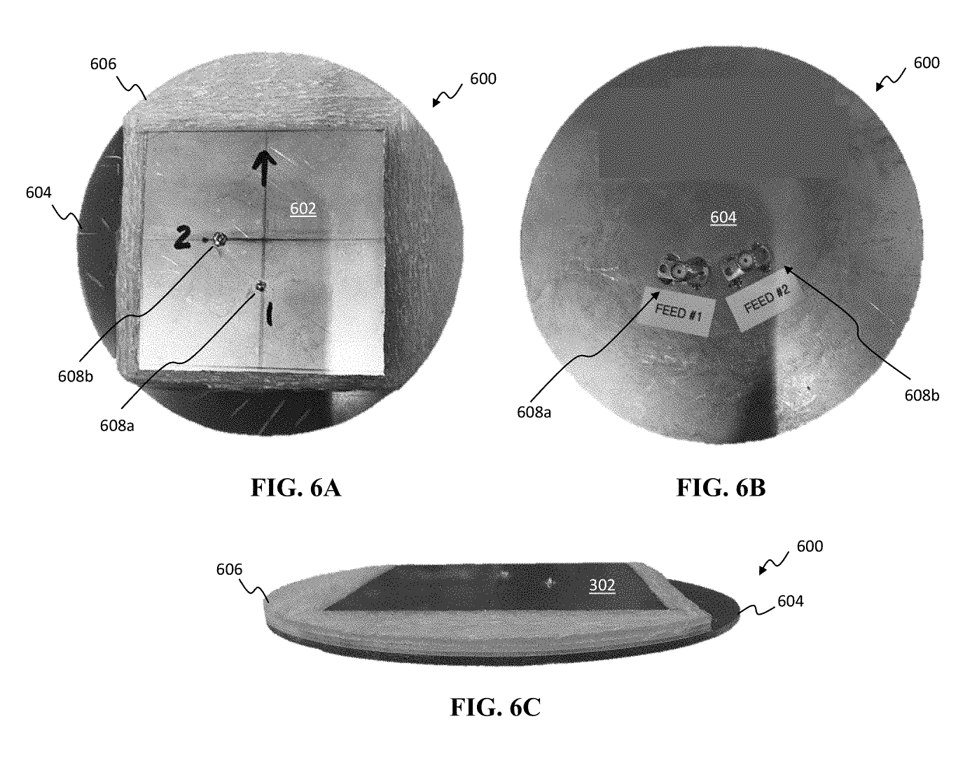

FIGS. 6A-6C depict an exemplary implementation of an antenna assembly 600 for a scanning device. As shown in FIG. 6A, the exemplary antenna assembly 600 includes a dual-linear dual-feed type patch antenna 602 with dimensions of approximately 3.1 inches by 3.1 inches (with 0.2 inch thickness) disposed on a printed circuit board (PCB). On the opposite side of the board (illustrated in FIG. 3B) is a groundplane 604 having a diameter of approximately 5 inches. The antenna 602 and groundplane 604 can each be made of copper, silver, or other conductor. The antenna 602 is separated from the groundplane 604 by a substrate (such as FR4) 606 of approximately 0.186 inches. The antenna 602 is coupled to two orthogonally-polarized feedpoints 608a, 608b and is configured to radiate at 900 to 950 MHz, or more specifically, 902-928 MHz. A scanning device having the exemplary antenna assembly 600 can be configured to detect RFID tags at least 5 meters away from the scanning device.

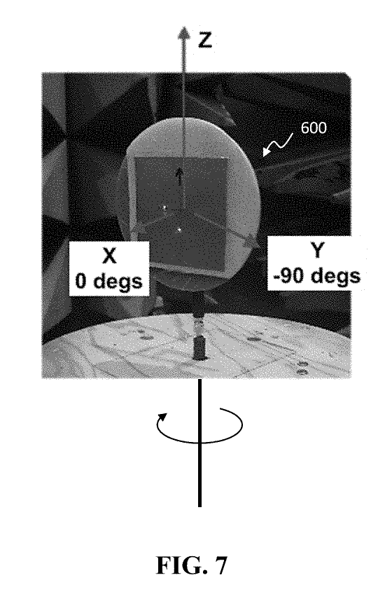

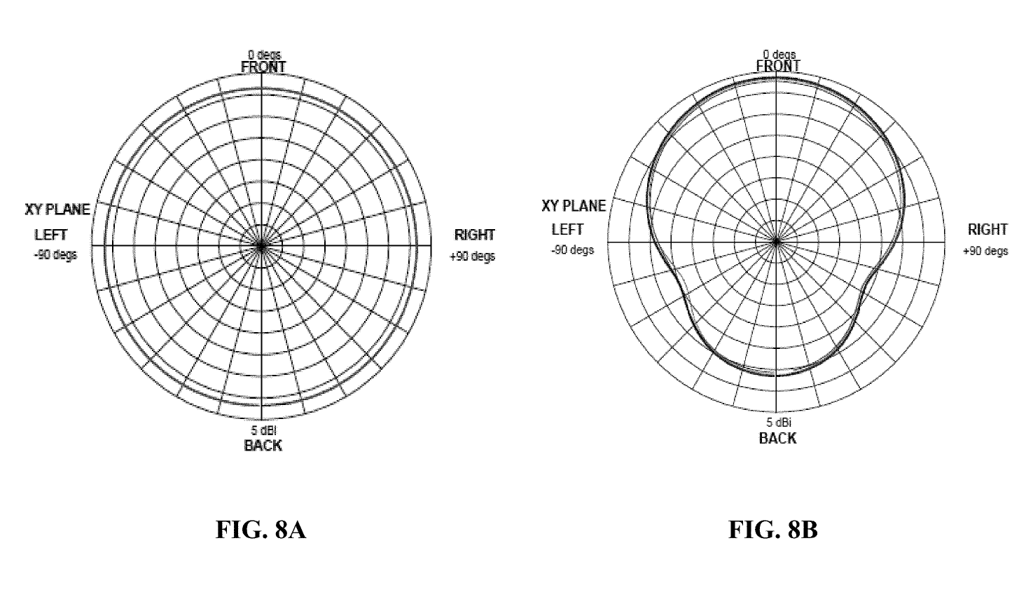

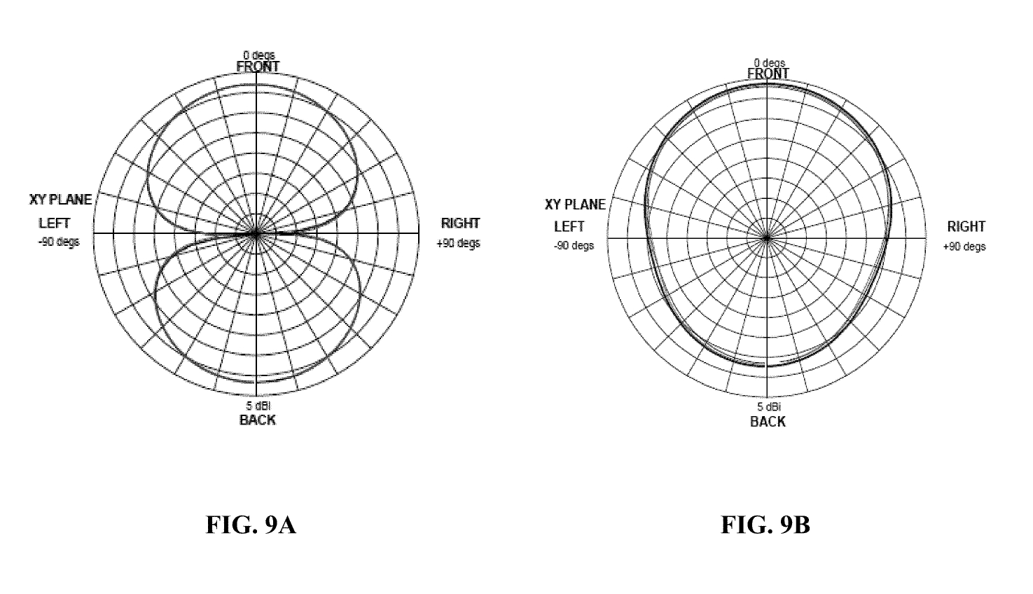

FIG. 7 depicts an experimental set-up of the antenna assembly 600 for the purposes of characterizing its polarization responses. FIGS. 8A-8B depict the vertical polarization responses of a reference antenna and the antenna assembly 600, respectively. FIGS. 9A-9B depict the horizontal polarization responses of a reference antenna and the antenna assembly 600, respectively.

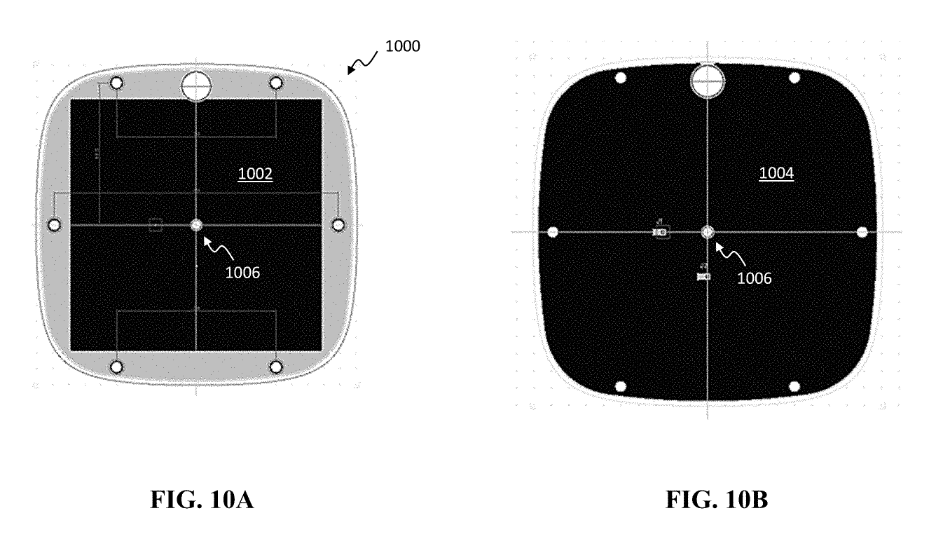

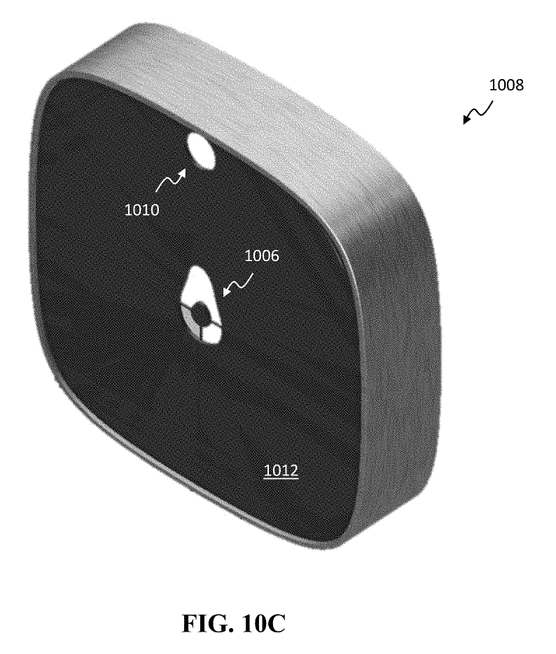

FIGS. 10A-10B depict an exemplary implementation of an antenna assembly 1000 for a scanning device. The antenna assembly 1000 includes an antenna 1002 disposed parallel to a groundplane 1004. In some implementations, the antenna assembly 1000 is coupled to a motion sensor. When the motion sensor detects motion (such as a person moving around in the motion detection space), the antenna assembly 1000 is powered on to radiate or scan for tags in the scanning area. Note that, in some implementations, antenna assembly 1000 includes a hole in the center for a light-emitting diode (LED) indicator 1006. The LED indicator 1006 is positioned such that it does not interfere with the radiation from the antenna. The LED indicator 1006 is configured with different colors to indicate various states of the scanning device, such as an “error state,” “configured state,” “scanner-active state,” “motion-sensed state,” “item-detected state,” etc. and any combination of the foregoing. For example, the “error state” may be indicated by the color red while an active state may be indicated with the color green. In some implementations, the packaging of the RFID sensor can include a layer of acrylic plastic. The use of this acrylic is advantageous because of its aesthetic quality and its “transparency” to RFID sensing signals. In other words, the acrylic does not impede or otherwise interact with RFID sensing signals and therefore allows for robust detection of RFID tags. FIG. 10C depicts an exemplary implementation of the packaging 1008 of the RFID scanning device, including a hole 1006 in the center for the LED indicator and a hole 1010 for the motion detector. Note that the packaging 1008 can incorporate acrylic plastic in surface 1012.

### Methods for Consumer Item Tracking

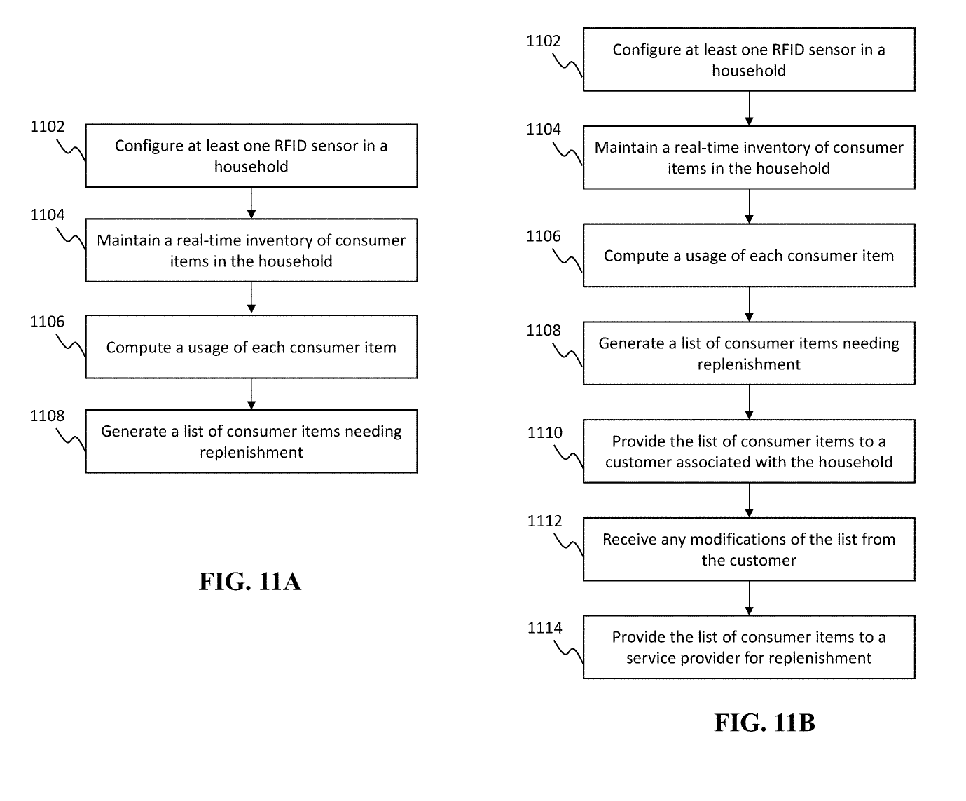

Configuration and use of the system can include the following. FIGS. 11A-11B depict methods for tracking consumer items using exemplary scanning device described herein. Before delivering each order of items for a customer, RFID tags are affixed to the items. In some implementations, the RFID tags are affixed to items on-the-fly after an order is received, when the items are purchased from a grocery store or other supplier, and before or during delivery by, for example, by a service provider that fulfills grocery orders (thereby allowing grocery stores, manufacturers, and others in the supply chain to be uninvolved in the tagging process). In other implementations, the items can be tagged by a distributor, manufacturer, or other party in advance of being received by the service provider. The tags can be manually or automatically affixed, e.g., by a robotic tagger. The tagging process can create a mapping between an identifier of the item (e.g., SKU, barcode, or other unique item id) and the RFID tag identifier that is delivered to customer's household, allowing for the updating of an item inventory map maintained for the household. The RFID tags are detectable by the scanning devices, which can be configured to ensure that different scanning devices do not overlap scanning regions (e.g., the trash area detection region does not overlap with the usage area detection region) (step 1102). The power of the scanning devices can be configured to ensure that they are accurate in locating all items in a desired area and not beyond.

The tagged items are then delivered to the customer, who then places these items into their respective storages. Detection of the tags on the items can be ignored when the customer first places the items. The usage area scanning device detects the items when they are used (i.e., when they enter the scanned area), and sends to a server information about how the usage is happening, including how long the item was used and how many times it was used. Finally, when that item is detected by the trash area scanning device, information is then sent to the server marking the item as trashed and removed from the inventory of items at the customer's home (step 1104). The usage information and the time of trashing allow the server to determine the average consumption per use for each item in the customer's inventory. This information is used to formulaically determine which item will be consumed by what time, as discussed in more detail below (step 1106). Machine learning techniques can be used to identify patterns to predict when the customer will run out of or otherwise discard an item. The server then creates a complete list of items that will need to be restocked at the customer's home (step 1108). This list can be sent to the customer, who can make modifications and update the items for restocking the next day (steps 1110, 1112). The items can be restocked by a service provider who receives the updated list of items and who may have access to the customer's household (step 1114). In other implementations, certain functionality can be performed locally, e.g., on the tracking devices or a home computer. For example, a learning system can reside on either a remote server of the service provider or a local tracking device. Either can maintain a mapping of each item and a total inventory of SKUs in a household.

More specifically, from the perspective of the customer, the service includes the following steps.
1. Installation: Scanning device(s) are installed in monitored areas, which can include a usage area and a trash area. The configuration can include placing tags specific to the system provider at the boundary of the trash area and configuring shielding and power of the scanning devices to ensure that items are not detected outside a monitored area, but always detected in that area.
2. Onboarding: Each existing consumable item at a customer's home is tagged on-the-fly and cataloged.
3. Weekly Service:
   a. “Average daily usage” of each item is determined based on signals from the Trash Area Detector and/or Usage Area Detector.
   b. Current inventory levels are identified, and estimations are calculated for how long each item will last. With this information about each item, the entire list of items to be replenished at the consumer home is determined.
   c. The customer is notified of what items will be replenished, and the customer is given a time limit (e.g., one day) to modify the list.
   d. The items on the modified list are delivered. As described above, a process called “on-the-fly” or “just-in-time tagging” can be used so that stores need not tag their inventory.
   e. Advantageously, the system provider can package items in groups according to the global “average daily use” of any given item. E.g., Roma tomatoes will be packaged in 3 tomatoes per package (for light users) or 10 tomatoes per package (for heavy users).

Referring more specifically to the installation stage, the customer, service provider, or some other party can designate an area within the home that is intended to be a “trash area.” This can be, for example, an area where trash is placed before it is transferred to outside bins, such as under the sink, an area outside the kitchen, a garbage bin or recycle bin location, and so on. Some customers do not necessarily keep empty items inside the home, in which case the trash area can be designated as an area through which items pass before reaching the garbage bins outside. In another implementation, sensors can be placed on garbage bins themselves, such as on a lid, to detect items entering the bins.

Installation of a scanning device in the usage area (e.g., in a kitchen) provides signals of how an item is being used. For example, if the usage of a particular item is higher than average, then an adjustment can be made such that restocking occurs at a higher frequency. Various techniques for determining product usage are contemplated.

### Tracking of Critical v. Non-Critical Products

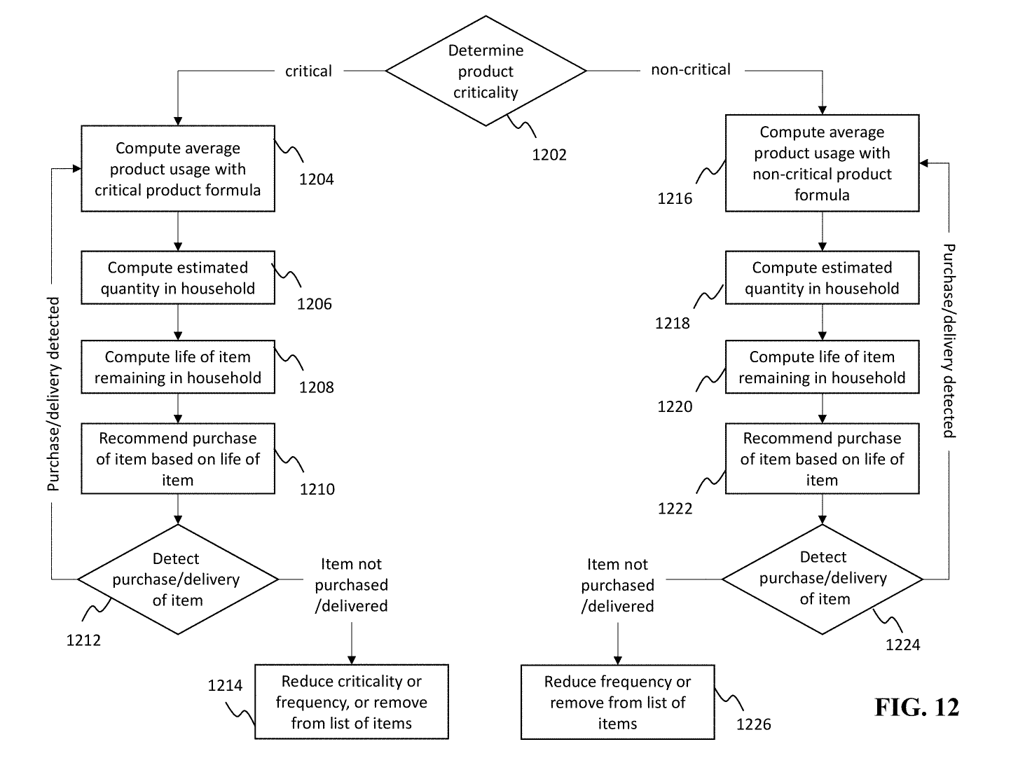

FIG. 12 depicts a method for determining the recommendation of a particular consumer item to the consumer of the household. In some implementations, a particular product is tracked according to its criticality to the consumer. In optional step 1202, the criticality of a particular product is identified by observing the first few events of the use timeline of the product. If, for instance, the use timeline appears as follows:

Delivery 1 . . . Delivery 2 . . . Trashing 1 . . . Delivery 3 . . . Trashing n−1 . . . Delivery n+1 . . . Trashing n
where n=3 or greater, the product is identified as a “critical product.” This is because more than one delivery of the product is received by the consumer before the trashing of the product (making it more likely that a backup product is available for the consumer's use). Such products may include toilet paper or diapers. If so, in step 1204, the average product usage is computed by:

Average usage=Weighted_Average(quantity delivered n+1/(time @ trashing_n−time @ trashing_n−1),previous average usage)

In the case of missed trashing events, the average product usage formula is computed by:

Average usage=quantity delivered n/time@ delivery n+1−time @delivery n−1

In step 1206, the estimated quantity of the consumer item in the household is computed by:

Estimated quantity=quantity delivered+estimated previous quantity @ delivery time−average usage

In step 1208, the life of the consumer item is computed by:

Item life=Estimated quantity/average usage

In step 1210, the system can recommend to the customer to purchase the item via the user interface before a future trashing event occurs. Note that the time at which to recommend the purchase of the item differs from item to item. For example, items with a long shelf life can be recommended 10-15 days prior to depletion of the item while items with a shorter shelf life can be recommended 3-4 days prior to depletion. In step 1212, the purchase and/or delivery of the item can be detected by the system. If the purchase and/or delivery occurs, then control passes back to step 1204. In step 1214, If the item is not purchased and/or delivered, any one or more of the following may occur: the criticality of the item can be reduced, the frequency of recommendation for purchase can be reduced, or the item can be removed from the household inventory.

If, in step 1202, the use timeline appears as follows:

### Delivery 1 . . . Trashing 1 . . . Delivery 2 . . . Trashing 2 . . . Delivery n . . . Trashing n

where n=3 or greater, the product is identified as a “non-critical product.” In step 1214, the average product usage is computed as follows:

Average usage=Weighted_Average(delivered_n/(Max(time @ trashing_n−time @ delivery_n−1),previous average usage)

Next, in step 1218, the estimated quantity in the household is based on the average product usage and is computed by:

Estimated quantity=quantity delivered+estimated previous quantity @ delivery time−average usage

In step 1220, the life of the item in the household is based on the average usage and estimated quantity and is computed by:

Item life=Estimated quantity/average usage

In step 1222, the system can recommend to the customer to purchase the item via the user interface before a future trashing event occurs. Note that the time at which to recommend the purchase of the item differs from item to item. For example, items with a long shelf life can be recommended 10-15 days prior to depletion of the item while items with a shorter shelf life can be recommended 3-4 days prior to depletion. In step 1224, the purchase and/or delivery of the item can be detected by the system. If the purchase and/or delivery occurs, then control passes back to step 1204. In step 1226, If the item is not purchased and/or delivered, any one or more of the following may occur: the criticality of the item can be reduced, the frequency of recommendation for purchase can be reduced, or the item can be removed from the household inventory.

In some implementations, multiple sensors (e.g., three or more sensors) can be used to identify the movement of items among various locations (e.g., different parts of the kitchen, in cabinets, refrigerator, etc.). This would include each of the sensors measuring received signal strength indicators (RSSIs) and determining from changes in the RSSIs that, for example, an item placed on a shelf was moved. This may not work with items in a refrigerator which is completely shielded; rather RFID sensors can be placed inside the refrigerator capture movement of tagged items. In another implementation, the RSSIs of multiple sensors can be evaluated to determine that the items are in the trash area. However, many trash cans are shielded (metallic) and may not give an accurate or timely indication of whether items were moved or not.

In one implementation, where only the trash area is monitored:

1) When replenishing a customer's items using “on-the-fly” or “just-in-time tagging” the system can utilize a mapping between a product id (SKU or barcode or item id in the system) and instance id[RFID] (e.g., a customer has RFID 1, RFID 2, and RFID 3 of Item 5).
2) Signals from the trash area are used to determine which instance of the item has been discarded (“item trashing”) and when (e.g., an exact time).
3) This above information is used to compute the number of current items at a person's home and determine the amount of time that the inventory has lacked one or more products.
4) The date-time of two different “item trashing” events allows the system to determine the immediate “average daily use of the item.”
5) Using (a) the current inventory (at the date of last “item trashing”)+any items replenished since (from step 1), (b) average daily use (from step 4), (c) date of the next replenishment (d1), and (d) date of next to next replenishment (d2), the system determines if the current stock will last until d2.
6) In one instance, the computation of “average daily use” is the weighted sum of the previous “average daily use” and the current “average daily use,” to account for customer using multiple instances of an item and discarding them within a short time period (e.g., a few days).

If there are multiple sensor areas (e.g., a usage area and a trash area), usage metrics other than average daily use can be used, such as “average consumption per use” or “extrapolated frequency of item use.” This extrapolation can use off-the-shelf machine learning regressions to understand the pattern of item use based on day of week, time of day, and/or other data, and predict when the next “item trashing” will occur, subsequently allowing for the determination of whether there are enough items or enough of an item to last through d2.

One will appreciate that the techniques described herein are applicable in various circumstances and are not limited merely to grocery inventory. For example, other consumable or disposable products, such as light bulbs, can be tagged with RFID tags. When a bulb is disposed of and the disposal is detected, another one can be automatically shipped to the household. As another example, sensors can be associated with laundry bags or “dirty clothes areas,” resulting in the automatic ordering of laundry service once a threshold of dirty clothes is reached.

Implementations of the system described herein can use appropriate hardware or software; for example, software used in the system can execute on hardware capable of running an operating system such as the Microsoft Windows® operating systems, the Apple OS X® operating systems, the Apple iOS® platform, the Google Android™ platform, the Linux® operating system and other variants of UNIX® operating systems, and the like. The system can include a plurality of software processing modules stored in a memory and executed on a processor. By way of illustration, the program modules can be in the form of one or more suitable programming languages, which are converted to machine language or object code to allow the processor or processors to execute the instructions. The software can be in the form of a standalone application, implemented in a suitable programming language or framework.

Additionally or alternatively, some or all of the functionality can be performed remotely, in the cloud, or via software-as-a-service. For example, certain functions can be performed on one or more remote servers or other devices that communicate with components of the system located within a household or other location. The remote functionality can execute on server class computers that have sufficient memory, data storage, and processing power and that run a server class operating system (e.g., Oracle® Solaris®, GNU/Linux®, and the Microsoft® Windows® family of operating systems). Communication between servers and user devices can take place over media such as standard telephone lines, LAN or WAN links (e.g., T1, T3, 56 kb, X.25), broadband connections (ISDN, Frame Relay, ATM), wireless links (802.11 (Wi-Fi), Bluetooth, GSM, CDMA, etc.), for example. Other communication media are contemplated. The network can carry TCP/IP protocol communications, and HTTP/HTTPS requests made by a web browser, and the connection between the user devices and servers can be communicated over such TCP/IP networks. Other communication protocols are contemplated.

Method steps of the techniques described herein can be performed by one or more programmable processors executing one or more computer programs to perform functions by operating on input data and generating output. Method steps can also be performed by, and the modules can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store instructions that, when executed by a processor, form the modules and other components described herein and perform the functionality associated with the components. The processor and the memory can be supplemented by, or incorporated in special purpose logic circuitry.

The system can also be practiced in distributed computing environments where tasks are performed by remote processing devices that are linked through a communications network. In a distributed computing environment, program modules can be located in both local and remote computer storage media including memory storage devices. Other types of system hardware and software than that described herein can also be used, depending on the capacity of the device and the amount of required data processing capability. The system can also be implemented on one or more virtual machines executing virtualized operating systems such as those mentioned above, and that operate on one or more computers having hardware such as that described herein.

It should also be noted that implementations of the systems and methods can be provided as one or more computer-readable programs embodied on or in one or more articles of manufacture. The program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The terms and expressions employed herein are used as terms and expressions of description and not of limitation, and there is no intention, in the use of such terms and expressions, of excluding any the equivalents of the features shown and described or portions thereof. In addition, having described certain implementations in the present disclosure, it will be apparent to those of ordinary skill in the art that other implementations incorporating the concepts disclosed herein can be used without departing from the spirit and scope of invention. The features and functions of the various implementations can be arranged in various combinations and permutations, and all are considered to be within the scope of the disclosed invention. Accordingly, the described implementations are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

What is claimed is:

1. An inventory tracking system comprising:
one or more sensors configured to detect consumer items, the one or more sensors comprising at least one of:
a first sensor configured to detect consumer items within a first area of a household in which the consumer items are used; and
a second sensor configured to detect consumer items within a second area of the household either in which the consumer items are discarded or through which the consumer items pass before being discarded; and
a computing device comprising at least one processor and at least one memory storing executable instructions that, when executed by the at least one processor, cause the at least one processor to perform the steps of:
maintaining a real-time inventory of consumer items in the household based on information received from the one or more sensors;
computing a usage of each consumer item based on information received from the one or more sensors and an usage formula; and
generating a list of consumer items needing replenishment based on information received from the one or more sensors and the computed usages.

2. The system of claim 1, wherein at least one of the first sensor and second sensor is an RFID sensor configured to detect RFID tags affixed to consumer items.

3. The system of claim 2, wherein at least one of the RFID sensors comprises a UHF RFID sensor configured to radiate with frequency in a range between 900 to 950 MHz.

4. The system of claim 2, wherein the RFID tags are affixed to the consumer items by a service provider as part of a process of delivering the consumer items to the household.

5. The system of claim 2, wherein the RFID tags comprise low cost UHF RFID paper tags or plastic tags.

6. The system of claim 2, wherein a housing of the RFID sensor comprises acrylic plastic such that RFID sensor is able to detect RFID tags through the acrylic plastic.

7. The system of claim 1, wherein at least one of the first sensor and second sensor is a vision-based sensor configured detect the consumer items.

8. The system of claim 1, wherein at least one of the first sensor and second sensor is a sound-based configured to sense one or more sounds associated with the consumer items.

9. The system of claim 1, wherein generating the list of consumer items comprises predicting a likelihood that the household will need to replenish a particular consumer item using a machine learning algorithm.

10. The system of claim 1, wherein the steps further comprise:
providing, via a user interface of the system, the list of consumer items to a customer associated with the household;
receiving, via the user interface, modifications of the list, if any, from the customer; and
providing the list of consumer items, with any modifications, to a service provider for replenishment of the listed consumer items.

11. The system of claim 1, wherein the usage is computed based on average use per a recurring time period.

12. The system of claim 11, wherein the time period is selected from the group consisting of a second, an hour, a day, a week, a month, and multiples of the foregoing.

13. The system of claim 1, wherein the computing the usage of each consumer item further comprises:
(i) computing average product usage for the consumer item;
(ii) computing estimated quantity of the consumer item in the household based on the average product usage;
(iii) computing a life of the consumer item; and
(iv) providing, via a user interface of the system, a recommendation for purchase of the consumer item based on the computed life.

14. The system of claim 13, wherein the computing the usage of each consumer item further comprises:
determining a criticality of the consumer item, wherein the average product usage is computed based on the criticality.

15. The system of claim 13, wherein the computing the usage of each consumer item further comprises:
determining at least one of purchase or delivery of the consumer item to the household;
if the consumer item is purchased or delivered to the household, repeating (i)-(iv); and
if the consumer item is not purchased or delivered to the household, determining future usage of the consumer item.

16. The system of claim 15, wherein, if the consumer item is not purchased or delivered to the household, further comprising:
removing the consumer item from the list of consumer items.

17. The system of claim 1, further comprising at least one of:
a first motion sensor coupled to the first sensor and configured to detect motion within the first area of the household, wherein the second motion sensor activates the first sensor upon detecting motion in the first area; and
a second motion sensor coupled to the second sensor and configured to detect motion within the second area of the household, wherein the second motion sensor activates the second sensor upon detecting motion in the second area.

18. In an inventory tracking system comprising one or more sensors configured to detect consumer items, a method comprising:
configuring at least one of:
a first sensor to detect consumer items within a first area of a household in which the consumer items are used; and
a second sensor to detect consumer items within a second area of the household either in which the consumer items are discarded or through which the consumer items pass before being discarded; and
maintaining, using a computing device, a real-time inventory of consumer items in the household based on information received from the one or more sensors;
computing, using the computing device, a usage of each consumer item based on information received from the one or more sensors and an usage formula; and
generating, using the computing device, a list of consumer items needing replenishment based on information received from the one or more sensors and the computed usages.

19. The method of claim 18, wherein at least one of the first sensor and second sensor is an RFID sensor configured to detect RFID tags affixed to consumer items.

20. The method of claim 19, wherein at least one of the RFID sensors comprises a UHF RFID sensor configured to radiate with frequency in a range between 900 to 950 MHz.

21. The method of claim 19, wherein the RFID tags are affixed to the consumer items by a service provider as part of a process of delivering the consumer items to the household.

22. The method of claim 19, wherein the RFID tags comprise low cost UHF RFID paper tags or plastic tags.

23. The method of claim 19, wherein a housing of the RFID sensor comprises acrylic plastic such that RFID sensor is able to detect RFID tags through the acrylic plastic.

24. The method of claim 18, wherein at least one of the first sensor and second sensor is a vision-based sensor configured detect the consumer items.

25. The method of claim 18, wherein at least one of the first sensor and second sensor is a sound-based configured to sense one or more sounds associated with the consumer items.

26. The method of claim 18, wherein generating the list of consumer items comprises predicting a likelihood that the household will need to replenish a particular consumer item using a machine learning algorithm.

27. The method of claim 18, further comprising:
providing, via a user interface of the system, the list of consumer items to a customer;
receiving, via the user interface, modifications of the list, if any, from the customer; and
providing the list of consumer items, with any modifications, to a service provider for replenishment of the listed consumer items.

28. The method of claim 18, wherein the usage is computed based on average use per a recurring time period.

29. The method of claim 28, wherein the time period is selected from the group consisting of a second, an hour, a day, a week, a month, and multiples of the foregoing.

30. The method of claim 18, wherein the computing the usage of each consumer item further comprises:
(i) computing average product usage for the consumer item;
(ii) computing estimated quantity of the consumer item in the household based on the average product usage;
(iii) computing a life of the consumer item; and
(iv) providing, via a user interface of the system, a recommendation for purchase of the consumer item based on the computed life.

31. The method of claim 30, wherein the computing the usage of each consumer item further comprises:
determining a criticality of the consumer item, wherein the average product usage is computed based on the criticality.

32. The method of claim 30, wherein the computing the usage of each consumer item further comprises:
determining at least one of purchase or delivery of the consumer item to the household;
if the consumer item is purchased or delivered to the household, repeating (i)-(iv); and
if the consumer item is not purchased or delivered to the household, determining future usage of the consumer item.

33. The method of claim 32, wherein, if the consumer item is not purchased or delivered to the household, further comprising:
removing the consumer item from the list of consumer items.

34. The method of claim 18, further comprising configuring at least one of:
a first motion sensor coupled to the first sensor and configured to detect motion within the first area of the household, wherein the second motion sensor activates the first sensor upon detecting motion in the first area; and
a second motion sensor coupled to the second sensor and configured to detect motion within the second area of the household, wherein the second motion sensor activates the second sensor upon detecting motion in the second area.
